(19) United States
(12) Patent Application Publication
(10) Pub. No.: US 2026/0094052 A1
(43) Pub. Date: Apr. 2, 2026

(54) ARTIFICIAL INTELLIGENCE POWERED WORKLOAD SIZING FOR GENERATIVE ARTIFICIAL INTELLIGENCE AUTHORING SYSTEMS

(71) Applicant: INTUIT INC., Mountain View, CA (US)

(72) Inventors: Ronnie Douglas DOUTHIT, Trinidad, TX (US); Deepankar MOHAPATRA, Plano, TX (US)

(21) Appl. No.: 18/901,689

(22) Filed: Sep. 30, 2024

(51) Int. Cl. G06N 20/00

(52) U.S. Cl. CPC G06N 20/00

(57) ABSTRACT

Aspects of the present disclosure relate to automatically generating artifacts. Embodiments include providing, to a machine learning model, an indication of a generative machine learning model, an indication of a type of an artifact, and an indication of a position, wherein the machine learning model is trained to predict a size for the segment of the artifact that is compliant with an input limit or a processing capacity of the generative machine learning model. Embodiments further include providing a segment of an artifact template to the generative machine learning model along with a prompt instructing the generative machine learning model to generate the segment of the artifact with the size predicted by the machine learning. Embodiments further include receiving, from the generative machine learning model, the segment of the artifact based on the segment of the artifact template and the prompt.

### INTRODUCTION

Aspects of the present disclosure relate to techniques for automatically generating artifacts. In particular, techniques described herein involve using a machine learning model to predict the largest size for an artifact segment that will not exceed an input limit or processing capacity of a generative machine learning model used to generate the segment. Based on this predicted size, a segment of the artifact may be generated.

### BACKGROUND

Computing systems play an ever-increasing role in modern society. Every year, millions of new software artifacts are developed and deployed to address the needs of people, businesses, and organizations around the world. Each of these software artifacts may require an extensive amount of manual coding to create. For example, team of software developers may spend several hours performing tedious coding tasks that are necessary to make a software application function properly.

Artificial intelligence has shown promise in reducing the need for tedious manual labor in many fields. For example, generative machine learning models may be used to summarize large bodies of text near-instantaneously. However, numerous technical challenges have hindered the use of generative machine learning models in generating code for software applications. As an example, an attempt to automatically generate software application code may fail due to the resource usage limit associated with a generative machine learning model being exceeded or a token limit of the model being exceeded. Such failures may not only waste time and computing resources, but also greatly complicate the artifact generation process. For example, if a failure occurs part of the way through generation, an incomplete segment of code may be returned, and the generative system may not be able to understand that the segment is incomplete, resulting in extensive errors. To avoid these problems, generating software application code may require generating the code segment-by-segment to avoid exceeding the processing capacity and/or input limit of the generative model. However, such segment-based generation presents an additional technical challenge: the potential for errors increases as the size of the segments decreases. For example, if the code for a software artifact can be generated in a single segment, aspects of the code such as variable names may be consistent throughout; however, if the code is broken up into several segments, a generative machine learning model may use inconsistent variable names and/or segments of the code may otherwise not properly fit together. Developers may be required to guess a size for a segment that is large enough to be efficient and minimize errors and also small enough to not exceed the capacity of the generative model. Using such trial and error to determine a size for a segment may result in wasted time and computing resources. Similar problems arise when using generative machine learning models to generate other types of artifacts. For example, artifacts such as images and bodies of text may require segment-by segment generation to avoid failure; the risk of inconsistencies may increase as the number of segments increases.

Thus, there is a need in the art for improved techniques of automatically generating artifacts.

### BRIEF SUMMARY

Certain embodiments provide a method of automatically generating artifacts. The method generally includes: providing, to a machine learning model, an indication of a generative machine learning model, an indication of a type of an artifact, and an indication of a position within the artifact of a segment of the artifact that is to be generated by the generative machine learning model, wherein the machine learning model is trained to predict a size for the segment of the artifact that is compliant with an input limit or a processing capacity of the generative machine learning model; providing a segment of an artifact template to the generative machine learning model along with a prompt instructing the generative machine learning model to generate the segment of the artifact with the size predicted by the machine learning model, wherein: the generative machine learning model has been trained to generate artifacts based on artifact templates; and the artifact template corresponds to the indicated type of the artifact; and receiving, from the generative machine learning model, the segment of the artifact based on the segment of the artifact template and the prompt.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automatically generating artifacts.

FIG. 2 depicts an example of template segments that may be used to generate an artifact.

FIG. 3 depicts an example sequence diagram for an automated artifact generation system.

FIG. 4 depicts example operations related to automatically generating artifacts.

FIG. 5 depicts an example of a processing system for automatically generating artifacts.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating artifacts.

According to certain embodiments, a machine learning model may be used to predict a size for a segment of an artifact. The prediction may be based on the type of artifact, as well as other factors such as an indication of a level of activity associated with a generative machine learning model used to generate the segment, one or more other parameters of the generative machine learning model, and/or the like. A segment of an artifact template corresponding to the predicted size may be provided to the generative machine learning model, which may generate a new segment of the artifact based on the provided template segment. If the generation of a segment fails due to the input limit and/or processing capacity of the generative machine learning model being exceeded, another machine learning model, such as a heuristic model, may predict a new size for the segment based on previous results.

Embodiments of the present disclosure provide numerous technical and practical effects and benefits. For example, techniques described herein allow for automatically identifying and using an optimal segment size (e.g., a size that minimizes the number of segments while not exceeding the capacity of the generative model) in automated artifact generation. When an optimal segment size is used, the performance of automated artifact generation systems is improved. For example, using an optimal segment size will save both time and computing resources by preventing failures that occur due to the capacity of a generative model being exceeded. Furthermore, because the number of segments is minimized to the extent possible, the amount of errors in the artifact may be reduced. Additionally, techniques described herein eliminate the need for trial and error-based guessing of an optimal segment size, thus further reducing the amount of wasted time and resources involved in automated artifact generation.

### Example of Computing Components Related to Automatically Generating Artifacts

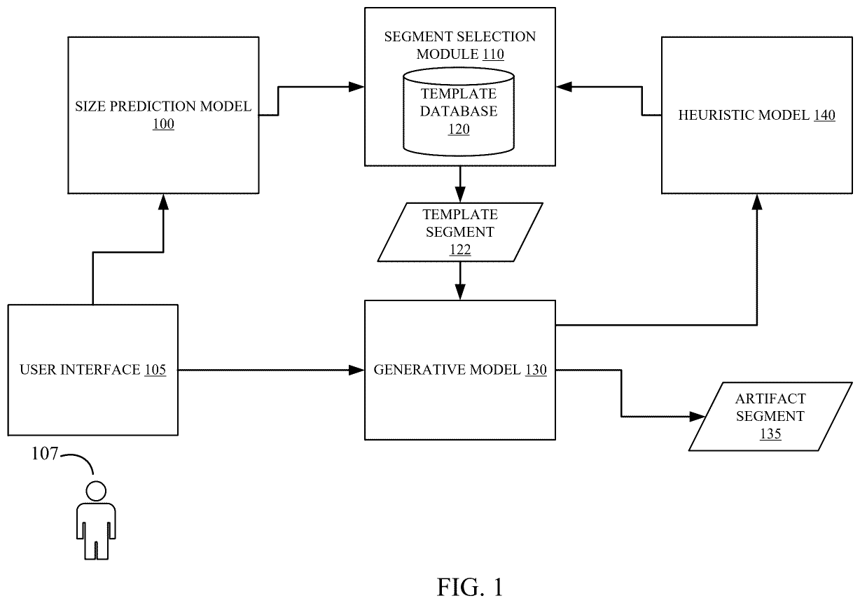

FIG. 1 depicts an example of computing components related to automatically generating artifacts.

A user 107 may interact with an artifact generation system through a user interface 105. The user interface 105 may allow the user 107 to indicate a type of artifact to generate. For example, if the user 107 wants to generate source code for an application programing interface (API) client, the user 107 may, via the user interface 105, prompt the artifact generation system to generate such code using the generative model 130. The artifact may be generated based on a template, such as a template provided by the user 105. While embodiments of the present disclosure may be used to generate software artifacts such as source code, the generated artifacts may be any type of artifact that a generative machine learning model is capable of generating. For example, a generated artifact may be an image or any type of text or other media.

The generative model 130 may generally be any type of model that is capable of generating artifacts. For example, the generative model 130 may include a generative machine learning model such as a Generative Adversarial Network (GAN), Variational Autoencoder (VAE), or a large language model (LLM). The generative model 130 may be a rule-based model that uses natural language processing techniques to generate text-based artifacts.

Details relating to the artifact to be generated (e.g., an indication of the type of artifact, a template of the artifact, and/or an indication of a generative model used to generate the artifact) may be provided as input to a size prediction model 100. The size prediction model 100 may be a machine learning model (e.g., a transformer model such as a neural network and/or the like) that is trained to predict a size for a segment of an artifact. The predicted size may be approximately the largest size that is compliant with an input limit and/or a processing capacity of the generative model 130. The processing capacity may include a time limit for generative tasks. For example, if a generative machine learning model is unable to generate a segment within a given period of time, a “timeout” may occur, resulting in failure to generate the segment.

An indication of the day or time may be provided as an input to the size prediction model 100. The day and/or time may correspond to the time of the request to generate the artifact. For example, the size prediction model 100 may be trained based on historical usage data associated with the generative model 130. The usage data may indicate that at certain times or on certain days of the week and/or month, the generative model 130 has higher rates of usage, while at other times and/or on other days of the week and/or month, the generative model 130 has lower rates of usage. As another example, the resource usage of the generative model 130 may be directly measured (e.g., based on the number of requests submitted to the generative model 130 during a time window preceding the request by the user 107). At periods of higher resource usage, the generative model 130 may be more likely to time out due to the processing capacity being exceeded. Thus, when a request to generate an artifact is submitted, the size prediction model 100 may generate an output indicating a size for a segment based on indications of the current or recent (e.g., within a time window) level of activity of the generative model 130.

The size may also be predicted based on the type of artifact being generated. For example, some artifacts may be more complicated than others. More complicated artifacts may be more likely to exceed the processing capacity of the generative model 130 than similarly-sized less complicated artifacts. Thus, for more complicated artifacts, the predicted size may be smaller. Complexity may be determined based on use cases. For example, each type of artifact may be associated with a level of complexity (e.g., based on the probability of failure in generating a typical artifact of the type, which may be indicated by a user and/or determined automatically based on past failures and/or successes of generating artifacts of particular types), and the size may be predicted based on the complexity.

The size prediction may also be based on the type of segment being generated. For example, a template may contain various parts, and some parts may require more resources to generate than others. An indication of a position of a segment within the artifact (e.g., the starting point of the segment) may also be provided to the size prediction model 100. For example, usage data may indicate that certain parts of an artifact are more likely to result in exceeding the processing capacity than other parts. When trained with such usage data, the size prediction model 100 may generate a predicted size that is based on the indicated position of the segment.

The size prediction model 100 may be trained to predict a size for a segment of an artifact (e.g., based on artifact complexity and/or generative model 130 usage) through a supervised learning process. Supervised learning techniques generally involve providing training inputs to a machine learning model. The machine learning model processes the training inputs and outputs predictions based on the training inputs. The predictions are compared to the known labels associated with the training inputs to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the predictions produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and/or the like. In some embodiments, validation and testing are also performed for a machine learning model, such as based on validation data and test data, as is known in the art.

The supervised learning process for the size prediction model 100 may involve a training data set comprising historical usage data associated with the generative model 130. A training data instance may comprise a type of artifact (e.g., a configuration file, source code for an API client, etc.), a time stamp associated with the request to generate the artifact (or another indication of a level of usage), a size of a segment of the artifact, an indication of the position of the segment within the artifact, an indication of whether the generation request failed, and/or (if applicable) an indication of the cause of the failure (e.g., whether a timeout occurred due to the processing capacity of the generative model being exceeded or whether an input limit was exceeded). The size prediction model 100 may be provided with features of a generated artifact segment such as the type, position, and the timestamp as inputs, and the size prediction model 100 may generate a predicted size as an output. The predicted size may be compared to the actual size of the generated artifact segment in the training data. If the predicted size is approximately the same as or larger than the actual size and the actual size exceeded the capacity of the generative model 130, then one or more parameters of the size prediction model 100 may be adjusted. If the predicted size is smaller than the actual size and the actual size did not exceed the capacity of the generative model 130, then one or more parameters of the size prediction model 100 may be adjusted. The comparison and adjustment may be iteratively repeated until one or more conditions are met, such as until the predicted size is approximately equal to (e.g., within a threshold distance of, but not exceeding) the actual size (e.g., if the actual size did not exceed the capacity of the generative model 130), until the predicted size is less than the actual size (e.g., if the actual size did exceed the capacity of the generative model 130), until an objective function is optimized, and/or the like.

The predicted size may be provided to a segment selection module 110, which may select a template segment 122 from a template database 120 based on the predicted size. For example, a user 107 may prompt the artifact generation system to generate source code for a plugin. The size prediction model 100 may predict a size for segments of the plugin, and the segment selection module 110 may select a segment of a plugin template of the predicted size. For example, the predicted size may be the first function within the plugin or the first twenty lines of code. Based on this predicted size, the first function of the plugin template or the first twenty lines of code of the plugin template may be retrieved by the segment selection module 110 and provided as input to the generative model 130. The generative model 130 may also be provided with a prompt comprising instructions to generate a segment of the predicted size (e.g., according to one or more parameters, such as specified by a user in a prompt provided by the user). The generative model 130 may generate an artifact segment 135 based on the template segment 122, the prompt, and/or and any additional information provided by the user 107. For example, the artifact segment 135 may be a version of the template segment 122 that is populated based on a goal of the user and/or data provided by a user.

After a first artifact segment 135 is generated, one or more subsequent artifact segments may be generated. For example, the same predicted size may be used for the second artifact segment. If the first twenty lines of the template were used for generating the first segment, the segment selection module 110 may retrieve the next twenty lines to provide to the generative model 130. In some embodiments, the size prediction model 100 may predict a new size for a subsequent segment. For example, a period of time may elapse between generating the first segment and generating the second segment. The size prediction model 100 may determine that a failure/timeout is more likely to occur at the time the second segment is to be generated, and thus the predicted size for the second segment may be smaller (and vice versa if the size prediction model 100 determines that failure/timeout is less likely to occur). Or, the size prediction model 100 may determine that the part of the template corresponding to the second segment is more complicated than the part corresponding to the first segment and thus predict a smaller size for the second segment. Such a determination may be made if the size prediction model 100 is trained based on the complexity of different segments. For example, a training data instance as described above may include the artifact and/or the segment of artifact template. Thus, the predicted sizes may be based on the code corresponding to the segment (e.g., simpler code may be contained in a larger segment, while more complex code is contained in a smaller segment).

The results of generating artifact segments (e.g., successes/failures) may be logged for training and retraining the size prediction model 100. For instance, after the artifact segment 135 is generated, data regarding the generation may be added to the historical usage data used to re-train the size prediction model 100, the size prediction model 100 may be re-trained based on such updated historical usage data, and the re-trained size prediction model 100 may be used to predict a size for a subsequent segment of the same artifact or a different artifact. This feedback loop allows for continuous improvement of the size prediction model 100. In certain embodiments, user feedback regarding generated segments may be used to retrain the size prediction model 100. For example, errors are more likely to be present in an artifact when the artifact is generated in several segments than when the artifact is generated in fewer segments. Users may identify errors in generated artifacts and provide feedback indicating the number of errors. Based on this feedback, the size prediction model 100 may be retrained (e.g., through a reinforcement learning process and/or another training process) to predict segment sizes that will result in fewer errors. The retrained size prediction model 100 may predict larger sizes for segments, such that the artifact will be generated in fewer segments.

In some instances, generation of an artifact segment may fail (e.g., due to a usage limit or a token limit of the generative model 130 being exceeded). In such cases, a heuristic model 140 may be used to predict a new size for the artifact segment. The heuristic model 140 may be a machine learning model or a rule-based model that predicts new sizes for an artifact segment based on the results of generating previous segments of the artifact. For example, in generating an artifact, the size prediction model may have selected a size of twenty lines for a first segment, twenty-five lines for a second segment, and thirty lines for a third segment. The first two segments may have been successfully generated, whereas the third segment may have failed to generate due to exceeding the capacity of the generative model 130. Based on these result, the heuristic model 140 may predict a new size of twenty-five lines for the third segment. If this fails, the heuristic model 140 may select a size of twenty lines. If segment generation is successful using a size predicted by the heuristic model 140, the heuristic model 140 may iteratively increase the predicted size on subsequent instances where the heuristic model 140 is invoked (e.g., until a size predicted by the heuristic model 140 leads to a failure).

In some embodiments, the heuristic model 140 may be used to reduce segment sizes even when segment generation does not fail. For example, generating a particular segment may narrowly avoid exceeding a time limit and/or another type of limit associated with the generative model 130. Inputs to the heuristic model 140 may include the processing time associated with completed segments and/or indications of the maximum time for segment generation. As an example, the inputs may include processing times of previously completed segments as well as processing times of segments that failed to generate (e.g., the inputs may include indications that a timeout occurred while generating a first segment after forty-five seconds and a second segment was successfully generated in thirty-five seconds). If the time required to generate a particular segment is close to resulting in a timeout, the heuristic model 140 may predict a smaller size for a subsequent segment (e.g., if the particular segment was generated in forty-three seconds, a smaller size may be predicted for the subsequent segment). In some cases, generative models are accessed behind a gateway which might, for example, cancel a request and return a timeout if the maximum time is exceeded. Thus, heuristic model 140 may be trained in some embodiments to reduce segment sizes when previous segments completed successfully but were near the maximum time and thus at risk of timeouts.

After each artifact segment is generated, the segments may be concatenated to form a complete artifact. For example, the complete artifact may be a complete set of code for a software application, a complete image, a complete body of text or other media item, and/or the like.

According to some embodiments, a prompt generation machine learning model may be trained to generate a prompt based on retrieved information associated with the segment of the artifact template. The prompt may be provided to the generative model 130, and the generative model 130 may generate an artifact segment based on the prompt. The generated prompt may provide supplemental information to help the generative model 130 understand how to generate the artifact segment. For example, the supplemental information may be generated based on a database that contains documentation (e.g., developer-written documentation) relating to the segment (e.g., embedding representations of the documentation may be stored in the database, and one or more embeddings may be retrieved based on using a semantic similarity algorithm to find documentation that is relevant to the template segment). Thus, if errors frequently occur involving a given portion of the artifact template, the developers may add documentation explaining the errors and how to avoid the errors. The prompt may be generated based on this documentation.

Certain embodiments provide that a model selection machine learning model may select a type of generative model to use based on the type of artifact and/or the complexity of an artifact/segment. For example, a simpler, more efficient model may be used to generate simpler artifacts, whereas a more complex model may be used to generate more complex artifacts. The model selection machine learning model may choose generative models based on usage rates. For example, if a generative model is more likely to fail to generate a segment because the usage of the generative model is high at the time, a different generative model may be chosen.

In some embodiments, an artificial intelligence (AI) agent comprising a machine learning model may be configured to generate artifacts using one or more computing components described herein. The AI agent may receive a prompt from the user 107 that indicates a type of artifact to create. Based on this prompt, the AI agent may orchestrate between the size prediction model 100, the segment selection module 110, and the generative model 130 to create the artifact. For example, the AI agent may invoke the segment selection module 110 to retrieve a template corresponding to the artifact. The template (and/or information about the template, such as the type of template and/or a starting position within the template) may be provided to the size prediction model 100, which may predict segment sizes. The AI agent may then use the predicted sizes to retrieve the segments of the template (e.g., by invoking the segment selection module 110). Generative model 130 may then be invoked and provided with the template segments. If segment generation fails, heuristic model 140 may be invoked by the AI agent, and the newly predicted size may be used to retrieve another segment.

### Example of Template Segments that may be Chosen to Generate an Artifact

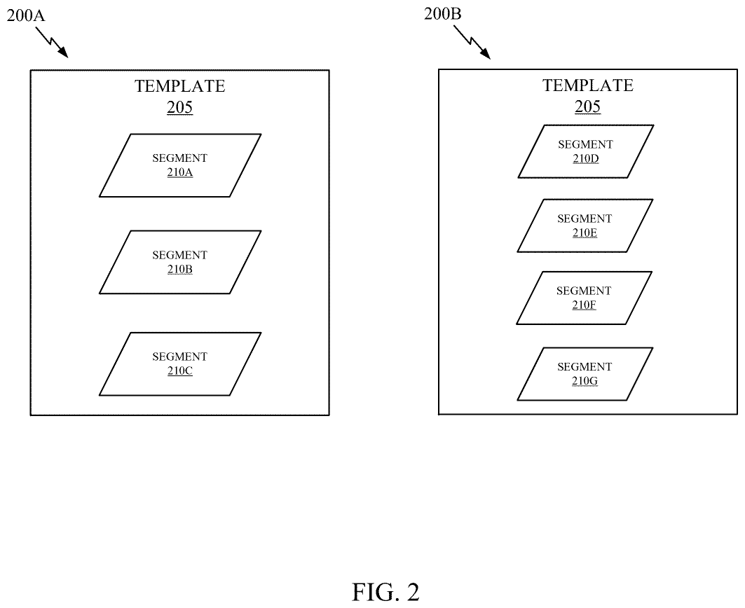

FIG. 2 depicts an example of template segments that may be used to generate an artifact.

The example template 205 shown in FIG. 2 may be a template of software code, an image, a body of text, or any other artifact that may be generated by a generative model. In example 200A, template 205 is divided into segments 210A, 210B, and 210C. Each segment 210 may have a respective size that is predicted by the size prediction model 100 of FIG. 1. For example, the segments may each have the same size: segment 210A may comprise the first twenty lines of template 205, segment 210B may comprise the next twenty lines of template 210B, and segment 210C may comprise the final twenty lines of template 205. As another example, the size prediction model may predict different sizes for each segment 210: segment 210A may comprise the first twenty lines of template 205, segment 210B may comprise the next twenty-five lines of template 210B, and segment 210C may comprise the final fifteen lines of template 205. For software artifacts, the segments may be partitioned such that functions or other structures within the segment are generated in the same segment (e.g., to avoid splitting structures into separate segments). For example, the predicted size may be based on functions within a template; functions may be included until a line limit is reached, and the function that would go over the line limit may be included in a subsequent segment. The sizes of the selected segments may be approximations of the predicted size (or, the predicted size may be a range). For example, for an artifact template may be sixty lines long, and the predicted size for segments of the template may be twenty lines. Segments of lengths twenty lines, twenty lines, and twenty-one lines may be used instead of segments of lengths twenty lines, twenty lines, twenty lines, and one line.

In example 200B, template 205 is divided into segments 210D, 210E, 210F, and 210G. These smaller segments 210D-G may be used because the artifact is being generated in a time associated with higher usage. Each of segments 210D-G may correspond to fifteen lines of the template 205. These segment configurations are intended as illustrative examples, and other configurations are possible. For example, longer or shorter templates may be used, larger or smaller segments may be used, and so on.

### Sequence Diagram for an Automated Artifact Generation System

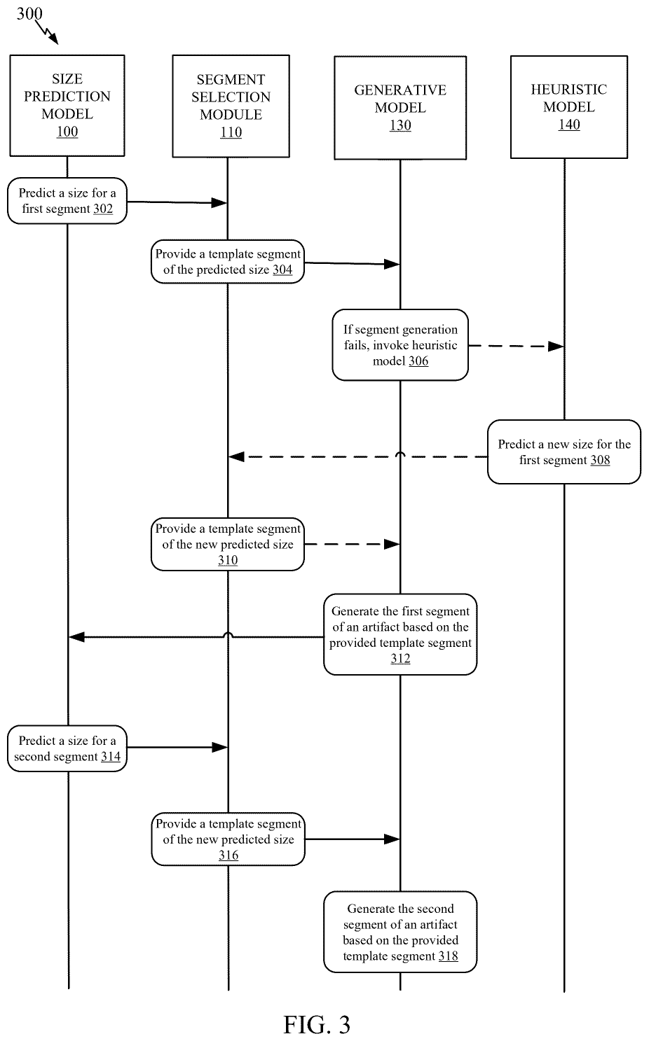

FIG. 3 illustrates a sequence diagram 300 for an automated artifact generation system according to some embodiments of the present disclosure. Sequence diagram 300 includes size prediction model 100, segment selection module 110, generative model 130, and heuristic model 140 of FIG. 1.

At 302, size prediction model 100 predicts a size for a first segment of an artifact. The predicted size may be a size that is large enough to minimize the risk of errors due to dividing the artifact into too many segments while being small enough to minimize the risk of generation failures (e.g., exceeding a token limit or usage limit). The size prediction model 100 may be trained to predict optimal sizes based on historical usage data associated with the generative model 130. The predicted size may be provided to the segment selection module 110. In some embodiments, the size prediction model 100 is retrained based on user feedback indicating a number of errors in an artifact and/or artifact segment.

At 304, the segment selection module 110 retrieves a segment of an artifact template based on the predicted size. The retrieved segment may be of the predicted size. For example, if the predicted size is two hundred lines, a segment that is two hundred lines long may be retrieved. The retrieved segment may be provided to the generative model 130.

At 306, the generative model 130 may attempt to generate a first segment of an artifact based on the segment of the template. If segment generation fails (e.g., due to a capacity of the generative model 130 being exceeded), the heuristic model 130 may be invoked.

At 308, the heuristic model 140 may be used to predict a new size for the segment based on the failure. The prediction may be based on previous results associated with generating segments of the artifact. For example, if one or more previous attempts to generate a segment failed, the heuristic model 140 may predict a size for the segment that is smaller than a size used in the previous attempts.

At 310, the segment selection module 110 retrieves a segment of an artifact template based on the size predicted by the heuristic model 140. The retrieved segment may be provided to the generative model 130.

At 312, the generative model 130 generates the first segment of the artifact. This segment may be based on a template segment provided by the segment selection module 110 and/or other inputs provided by a user.

At 314, size prediction model 100 predicts a size for a second segment of the artifact. The predicted size may be provided to the segment selection module 110. In some embodiments, the same size that was used for the first segment is used for the second segment, and the size prediction model 100 is not invoked to determine the size of the second segment.

At 316, the segment selection module 110 retrieves a segment of the artifact template based on a predicted size and provides the segment to the generative model 130. For example, if the first segment was generated based on the first twenty lines of the template, a number of lines corresponding to the predicted size after the first twenty lines may be retrieved (e.g., the next thirty lines, if the predicted size is thirty).

At 318, generative model 130 may generate a second segment of the artifact. This segment may be based on a template segment provided by the segment selection module 110 and/or other inputs provided by a user.

The sequence described above may be repeated until every segment of the artifact is generated. Then, a complete artifact may be created by concatenating all of the segments.

### Example Operations Related to Automatically Generating Artifacts

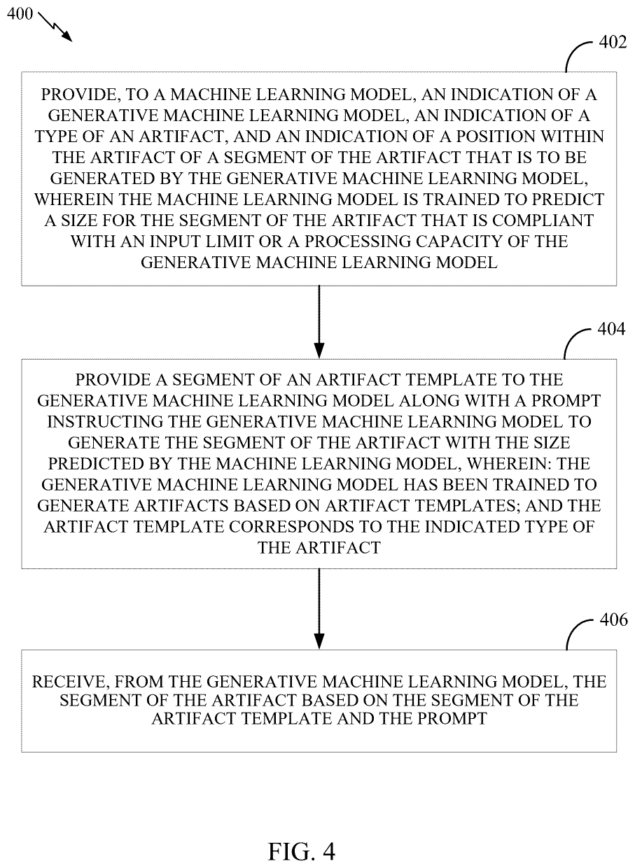

FIG. 4 depicts example operations 400 related to automatically generating artifacts. For example, operations 400 may be performed by one or more of the components described with respect to FIG. 1.

Operations 400 begin at step 402 with providing, to a machine learning model, an indication of a generative machine learning model, an indication of a type of an artifact, and an indication of a position within the artifact of a segment of the artifact that is to be generated by the generative machine learning model, wherein the machine learning model is trained to predict a size for the segment of the artifact that is compliant with an input limit or a processing capacity of the generative machine learning model. In some embodiments, the machine learning model predicts the size based on a day or time associated with generating the segment of the artifact. Some embodiments provide that the machine learning model is trained based on historical usage data associated with the generative machine learning model. According to some embodiments, the input limit comprises a token limit for the generative machine learning model. In certain embodiments, the processing capacity comprises a usage limit for the generative machine learning model.

Operations 400 continue at step 404 with providing a segment of an artifact template to the generative machine learning model along with a prompt instructing the generative machine learning model to generate the segment of the artifact with the size predicted by the machine learning model, wherein: the generative machine learning model has been trained to generate artifacts based on artifact templates; and the artifact template corresponds to the indicated type of the artifact. In certain embodiments, a prompt generation machine learning model is trained to generate a prompt based on information associated with the segment of the artifact template that is retrieved from one or more data sources. The prompt may be provided to the generative machine learning model. Certain embodiments provide that a model selection machine learning model is trained to select a type of generative machine learning model based on an indicated level of complexity associated with an artifact. The type of generative model may be used to generate a segment of the artifact.

Operations 400 continue at step 406 with receiving, from the generative machine learning model, the segment of the artifact based on the segment of the artifact template and the prompt. Certain embodiments provide that an additional segment of the artifact is generated based on retrieving an additional segment of the artifact template, wherein the additional segment of the artifact template is retrieved based on the size of the segment of the artifact.

Certain embodiments further comprise generating a complete artifact based on generating multiple artifact segments. For example, a complete artifact may be generated based on concatenating multiple artifact segments.

In some embodiments, generating a given segment of the artifact may fail due to a capacity of the generative machine learning model being exceeded. In such cases, an additional machine learning model may generate an output indicating a new size for a segment of the artifact based on results of previous attempts to generate segments of the artifact.

### Example of a Processing System for Automatically Generating Artifacts

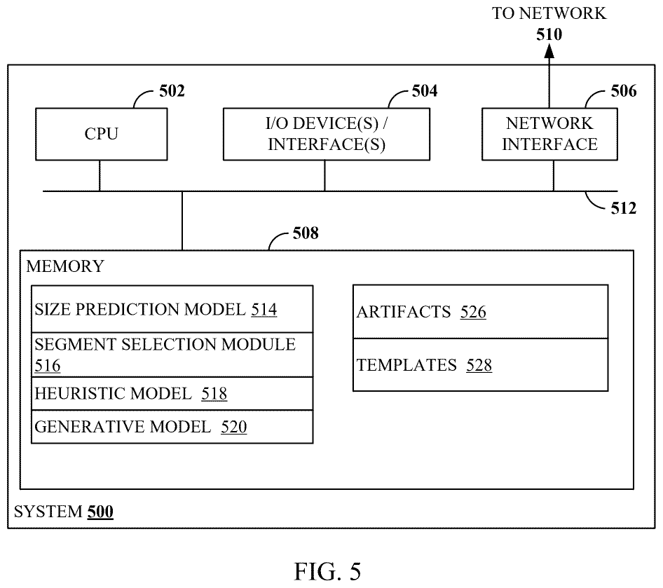

FIG. 5 illustrates an example system 500 with which embodiments of the present disclosure may be implemented. For example, system 500 may be configured to perform operations 400 of FIG. 4 and/or to implement one or more components as in FIG. 1.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes size prediction model 514, segment selection module 516, heuristic model 518, and generative model 520. Size prediction model 514 may be representative of size prediction model 100 of FIG. 1. In some embodiments, segment selection module 516 may be representative of segment selection module 110 of FIG. 1. Heuristic model 518 may be representative of heuristic model 140 of FIG. 1. Generative model 520 may be representative of generative model 130 of FIG. 1.

Memory 508 further comprises artifacts 526 which may correspond to one or more artifact segments 135 of FIG. 1. Memory 508 further comprises templates 528, which may include templates contained in template database 120 of FIG. 1 or template 205 of FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automatically generating artifacts, comprising:
providing, to a machine learning model, an indication of a generative machine learning model, an indication of a type of an artifact, and an indication of a position within the artifact of a segment of the artifact that is to be generated by the generative machine learning model, wherein the machine learning model is trained to predict a size for the segment of the artifact that is compliant with an input limit or a processing capacity of the generative machine learning model;
providing a segment of an artifact template to the generative machine learning model along with a prompt instructing the generative machine learning model to generate the segment of the artifact with the size predicted by the machine learning model, wherein:
the generative machine learning model has been trained to generate artifacts based on artifact templates; and
the artifact template corresponds to the indicated type of the artifact; and
receiving, from the generative machine learning model, the segment of the artifact based on the segment of the artifact template and the prompt.

2. The method of claim 1, further comprising generating a complete artifact based on generating multiple artifact segments.

3. The method of claim 1, wherein an additional segment of the artifact is generated based on retrieving an additional segment of the artifact template, wherein the additional segment of the artifact template is retrieved based on the size of the segment of the artifact.

4. The method of claim 1, wherein generating a given segment of the artifact fails due to a capacity of the generative machine learning model being exceeded, wherein an additional machine learning model generates an output indicating a new size for the given segment of the artifact based on results of previous attempts to generate segments of the artifact.

5. The method of claim 1, wherein the machine learning model predicts the size based on a day or time associated with generating the segment of the artifact.

6. The method of claim 1, wherein the machine learning model is trained based on historical usage data associated with the generative machine learning model.

7. The method of claim 1, wherein the input limit comprises a token limit for the generative machine learning model.

8. The method of claim 1, wherein the processing capacity comprises a usage limit for the generative machine learning model.

9. The method of claim 1, wherein a prompt generation machine learning model is trained to generate a prompt based on information associated with the segment of the artifact template that is retrieved from one or more data sources, wherein the prompt is provided to the generative machine learning model.

10. The method of claim 1, wherein a model selection machine learning model is trained to select a type of generative machine learning model based on an indicated level of complexity associated with an artifact, wherein the type of generative model is used to generate a segment of the artifact.

11. A system for automatically generating artifacts, comprising:
one or more processors; and
a memory comprising instructions that, when executed by the one or more processors, cause the system to:
provide, to a machine learning model, an indication of a generative machine learning model, an indication of a type of an artifact, and an indication of a position within the artifact of a segment of the artifact that is to be generated by the generative machine learning model, wherein the machine learning model is trained to predict a size for the segment of the artifact that is compliant with an input limit or a processing capacity of the generative machine learning model;
provide a segment of an artifact template to the generative machine learning model along with a prompt instructing the generative machine learning model to generate the segment of the artifact with the size predicted by the machine learning model, wherein:
the generative machine learning model has been trained to generate artifacts based on artifact templates; and
the artifact template corresponds to the indicated type of the artifact; and
receive, from the generative machine learning model, the segment of the artifact based on the segment of the artifact template and the prompt.

12. The system of claim 11, wherein the instructions further cause the system to generate a complete artifact based on generating multiple artifact segments.

13. The system of claim 11, wherein the instructions further cause the system to generate an additional segment of the artifact based on retrieving an additional segment of the artifact template, wherein the additional segment of the artifact template is retrieved based on the size of the segment of the artifact.

14. The system of claim 11, generating a given segment of the artifact fails due to a capacity of the generative machine learning model being exceeded, wherein an additional machine learning model generates an output indicating a new size for the given segment of the artifact based on results of previous attempts to generate segments of the artifact.

15. The system of claim 11, wherein the machine learning model predicts the size based on a day or time associated with generating the segment of the artifact.

16. The system of claim 11, wherein the machine learning model is trained based on historical usage data associated with the generative machine learning model.

17. The system of claim 11, wherein the input limit comprises a token limit for the generative machine learning model.

18. The system of claim 11, wherein the processing capacity comprises a usage limit for the generative machine learning model.

19. The system of claim 11, wherein a prompt generation machine learning model is trained to generate a prompt based on information associated with the segment of the artifact template that is retrieved from one or more data sources, wherein the prompt is provided to the generative machine learning model.

20. The system of claim 11, wherein a model selection machine learning model is trained to select a type of generative machine learning model based on an indicated level of complexity associated with an artifact, wherein the type of generative model is used to generate a segment of the artifact.
